(19) United States
(12) Patent Application Publication
(10) Pub. No.: US 2026/0181741 A1
(43) Pub. Date: Jun. 25, 2026

(54) PRESSURE-CONTROLLED SOLID PRECURSOR HEATING DEVICE

(71) Applicant: Jiashan Zhuoyi Kaisheng Technology Co., Ltd., Jiaxing City (CN)

(72) Inventors: Hung-Ming Chen, Taichung City (TW); Hsing-Chu Chen, Taichung City (TW); Xun-Wei Wang, Taichung City (TW)

(21) Appl. No.: 19/038,914

(22) Filed: Jan. 28, 2025

(30) Foreign Application Priority Data
Dec. 19, 2024 (TW) 113214048

(51) Int. Cl. H05B 1/02; H05B 6/06; H05B 6/10

(52) U.S. Cl. CPC H05B 1/0233; H05B 6/06; H05B 6/10

(57) ABSTRACT

A pressure-controlled solid precursor heating device includes a steel cylinder, a plurality of trays, a buffering container, a pressure gage, and an induction heater. The steel cylinder has a bottom plate and a peripheral wall, the two of which define an interior space. The trays are vertically stacked in the interior space in a separable manner and each have an accommodating space, a supporting plate, an annular side, and a circular ring, with the accommodating space defined between the supporting plate, the annular side, and the circular ring. The buffering container has a buffering space fluidly connected to the interior space. The pressure gage is provided at the buffering container and senses the vapor pressure in the buffering space. The induction heater is in signal connection with the pressure gage and heats the steel cylinder, by induction heating, according to the vapor pressure sensed by the pressure gage.

### BACKGROUND OF THE INVENTION

### 1. Technical Field

The present invention relates to a heating device for use in producing a vapor-phase chemical reagent.

### 2. Description of Related Art

Vapor-phase reagents are used in vapor-utilizing processes in semiconductor manufacture and other similar industrial applications. These vapor-phase reagents are produced by heating, and eventually sublimating, their respective solid precursors in a heating device.

A conventional heating device for such a solid precursor works as follows. The steel cylinder of the heating device is heated with an external heat source and conducts the heat received to the solid precursor in the steel cylinder in order to sublimate the solid precursor. A temperature-sensing element is provided outside the steel cylinder to sense the external temperature of the steel cylinder, and the temperature sensed is used to control the heating operation of the external heat source. The problem of the foregoing prior art lies in the fact that there is a difference between the temperatures inside and outside the steel cylinder; in other words, the external temperature sensed by the temperature-sensing element is not an accurate indicator of the internal temperature of the steel cylinder. Controlling the heating operation of the external heat source according to the external temperature tends to cause control delay, which renders the sublimation pressure of the solid precursor unstable.

### BRIEF SUMMARY OF THE INVENTION

The primary objective of the present invention is to provide a solid precursor heating device that can control the vapor pressure of the solid precursor stably.

To achieve the above and other objectives, the present invention provides a pressure-controlled solid precursor heating device that includes a steel cylinder, a plurality of vertically stacked trays, a buffering container, a pressure gage, and an induction heater. The steel cylinder has a bottom plate and a peripheral wall, and the bottom plate and the peripheral wall define an interior space. The trays are provided in the interior space in a separable manner. Each tray has an accommodating space, a supporting plate, an annular side, and a circular ring, wherein: the accommodating space is defined between the supporting plate, the annular side, and the circular ring; the supporting plate is connected to a bottom portion of the annular side and is configured to support a solid precursor; the circular ring is connected to a top portion of the annular side; and the annular side is in close contact with the peripheral wall. The lowest one of the trays is defined as the bottom tray, and the supporting plate of the bottom tray does not have a hollow portion. The supporting plate of each tray other than the bottom tray rests on the circular ring of the tray immediately below. The buffering container has a buffering space, and the buffering space is fluidly connected to the interior space. The pressure gage is provided at the buffering container and is configured to sense the vapor pressure in the buffering space. The induction heater is in signal connection with the pressure gage and is configured to heat the steel cylinder, by induction heating, according to the vapor pressure sensed by the pressure gage.

The present invention is advantageous in that, by monitoring the vapor pressure in the buffering space and performing feedback control on the induction heater, the vapor pressure in the buffering container can be maintained within a preset range, thereby reducing fluctuations in pressure of the resulting vapor-phase chemical reagent when the vapor-phase chemical reagent is subsequently supplied to a vapor-utilizing process.

### BRIEF DESCRIPTION OF THE SEVERAL VIEWS OF THE DRAWINGS

FIG. 1 is a schematic drawing of an embodiment of the present invention.

FIG. 2 is a perspective view of some of the components of the embodiment shown in FIG. 1.

FIG. 3 is an exploded view of some of the components of the embodiment shown in FIG. 1.

FIG. 4 is a sectional view of some of the components of the embodiment shown in FIG. 1.

### DETAILED DESCRIPTION OF THE INVENTION

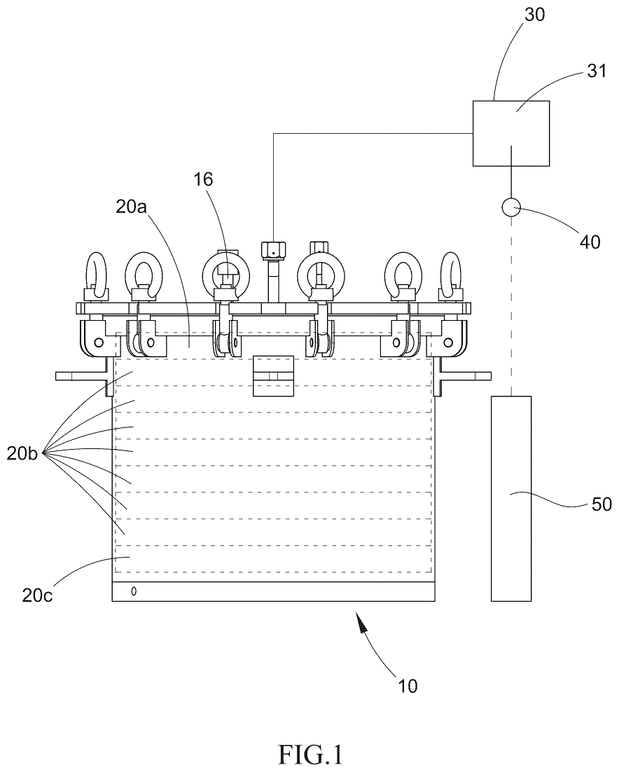

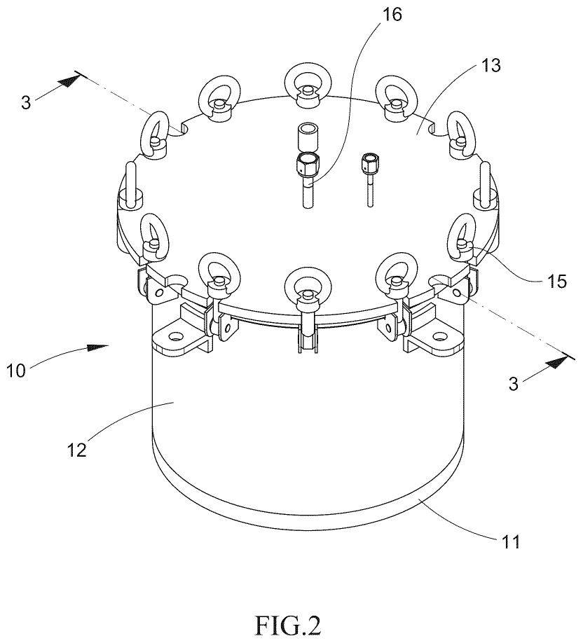

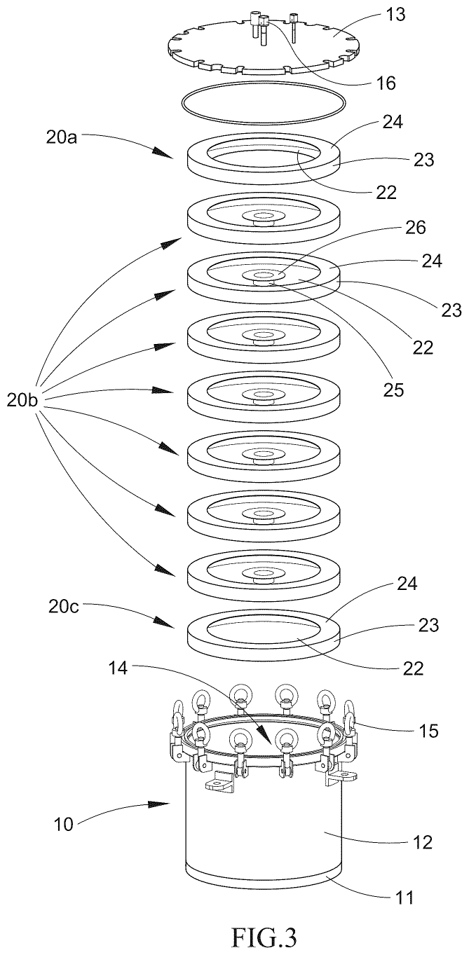

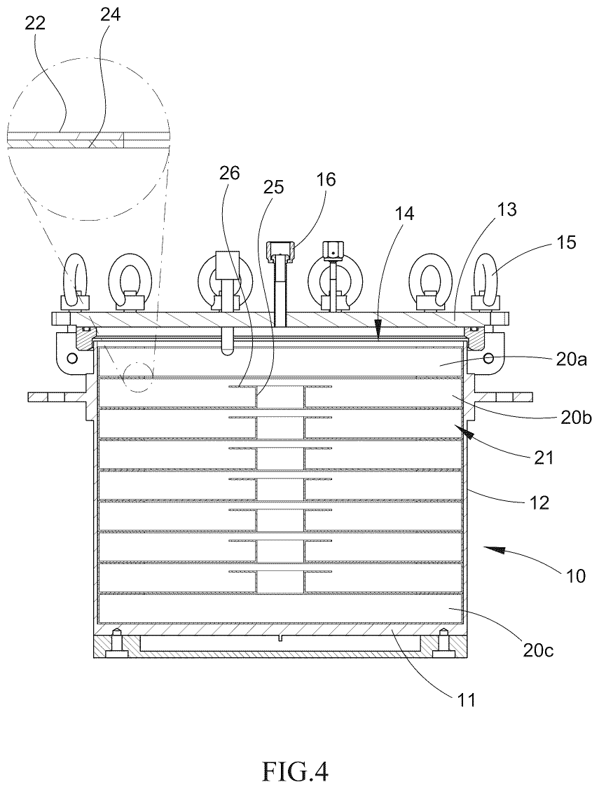

Referring to FIG. 1 to FIG. 4 for an embodiment of the pressure-controlled solid precursor heating device of the present invention, the solid precursor heating device includes a steel cylinder 10, a plurality of vertically stacked trays 20a, 20b, and 20c, a buffering container 30, a pressure gage 40, and an induction heater 50.

The steel cylinder 10 has a bottom plate 11, a peripheral wall 12, and a cover 13. The bottom plate 11 and the peripheral wall 12 define an interior space 14. The cover 13 is provided on a top portion of the peripheral wall 12 in a separable manner. The steel cylinder 10 may further have a plurality of locking elements 15 for locking the cover 13 to the top portion of the peripheral wall 12. In addition, the steel cylinder 10 has a vapor output pipe 16 provided at the cover 13, communicating with the interior space 14, and configured to output a vaporized chemical reagent. In a feasible mode of implementation, the steel cylinder 10 is made of stainless steel, and the magnetic permeability of the steel cylinder 10 (in particular of the peripheral wall 12) is preferably higher than 1 H/m, such as in the range from 1.04 to 1.05 H/m. In a feasible mode of implementation, the stainless steel in use may contain the following ingredients: not more than 1 wt % of nickel (Ni), 17-20 wt % of chromium (Cr), 1.75-2.5 wt % of molybdenum (Mo), not more than 0.025 wt % of carbon (C), not more than 0.035 wt % of nitrogen (N), about 0.8 wt % of titanium (Ti) and niobium (Nb) in total, and iron (Fe) making up the remaining percentage. Preferably, the nickel content is not more than 0.6 wt %, the chromium content is 17.5-19.5 wt %, and the nitrogen content is not more than 0.025 wt %. A stainless steel having the foregoing composition has good thermal conductivity and can be heated efficiently by induction heating.

The trays 20a, 20b, and 20c are provided in the interior space 14 in a separable manner. Each tray 20a/20b/20c has an accommodating space 21, a supporting plate 22, an annular side 23, and a circular ring 24, wherein: the accommodating space 21 is defined between the supporting plate 22, the annular side 23, and the circular ring 24; the supporting plate 22 is connected to a bottom portion of the annular side 23 and is configured to support a solid precursor (e.g., a tungsten precursor or a molybdenum precursor) that can be heated and thereby vaporized into a vapor-phase chemical reagent; the circular ring 24 is connected to a top portion of the annular side 23; and the annular side 23 is in close contact with the peripheral wall 12 so that the heat of the steel cylinder 10 can be conducted to the trays. The lowest one of the trays is defined as the bottom tray 20c, and the supporting plate 22 of the bottom tray 20c does not have a hollow portion. The trays other than the bottom tray 20c (i.e., the trays 20a and 20b) each have their supporting plate 22 resting on the circular ring 24 of the tray immediately below. The uppermost one of the trays is defined as the top tray 20a, and the supporting plate 22 of the top tray 20a has a central hollow portion. There is at least one tray, defined as a middle tray 20b, between the bottom tray 20c and the top tray 20a (in this embodiment, there are a plurality of middle trays 20b). Provided at the center of the supporting plate 22 of each middle tray 20b are a vertical cylindrical member 25 that is open at the top end as well as at the bottom end and an inner circular ring 26 that extends radially outward from the top end of the vertical cylindrical member 25. The height of the vertical cylindrical member 25 of each middle tray 20b is less than the height of the annular side 23 of the middle tray 20b so that a vapor-phase chemical reagent can be output through the passageway formed by the vertical cylindrical members 25 and then through the vapor output pipe 16.

The buffering container 30 has a buffering space 31. The buffering space 31 is fluidly connected to the interior space 14 so that a vapor-phase chemical reagent can be supplied from the interior space 14 into the buffering space 31. The pressure gage 40 is provided at the buffering container 30 and is configured to sense the vapor pressure in the buffering space 31. The induction heater 50 is in signal connection with the pressure gage 40 and is configured to heat the steel cylinder 10, by an induction heating method, according to the vapor pressure sensed by the pressure gage 40. More specifically, when the vapor pressure sensed is lower than the required vapor pressure range, the induction heater 50 either is started to heat, or increases its power of heating, the steel cylinder 10 directly; as a result, the solid precursor in the steel cylinder 10 is heated indirectly, producing more vapor-phase chemical reagent to be supplied to, for example, a vapor-utilizing process. When the vapor pressure sensed is higher than the required vapor pressure range, the induction heater 50 either is turned off or reduces its heating power, thereby reducing the heat supplied to the steel cylinder 10 and hence the production of the vapor-phase chemical reagent to be supplied to the vapor-utilizing process. The supply pressure of the vapor-phase chemical reagent can therefore be maintained more stably than achievable with the prior art, and this solves the problem of control delay, which is typical of the prior art. Moreover, the induction heating method used in the present invention has higher energy efficiency than the conventional method of heating a steel cylinder through thermal conduction.

What is claimed is:

1. A pressure-controlled solid precursor heating device, comprising:
a steel cylinder having a bottom plate and a peripheral wall, wherein the bottom plate and the peripheral wall define an interior space;
a plurality of vertically stacked trays provided in the interior space in a separable manner, wherein each said tray has an accommodating space, a supporting plate, an annular side, and a circular ring; wherein in each said tray, the accommodating space is defined between the supporting plate, the annular side, and the circular ring, the supporting plate is connected to a bottom portion of the annular side and is configured to support a solid precursor, the circular ring is connected to a top portion of the annular side, and the annular side is in close contact with the peripheral wall; wherein the lowest one of the trays is defined as a bottom tray, and the supporting plate of the bottom tray does not have a hollow portion; and wherein the supporting plate of each said tray other than the bottom tray rests on the circular ring of a said tray immediately below;
a buffering container having a buffering space, wherein the buffering space is fluidly connected to the interior space;
a pressure gage provided at the buffering container and configured to sense a vapor pressure in the buffering space; and
an induction heater in signal connection with the pressure gage, wherein the induction heater is configured to heat the steel cylinder, by induction heating, according to the vapor pressure sensed by the pressure gage.

2. The pressure-controlled solid precursor heating device of claim 1, wherein the steel cylinder further has a cover provided on a top portion of the peripheral wall in a separable manner.

3. The pressure-controlled solid precursor heating device of claim 1, wherein the uppermost one of the trays is defined as a top tray, and the supporting plate of the top tray has a central hollow portion.

4. The pressure-controlled solid precursor heating device of claim 3, wherein there is at least one said tray between the bottom tray and the top tray, the at least one tray is defined as a middle tray, the supporting plate of the middle tray is centrally provided with a vertical cylindrical member and an inner circular ring, the vertical cylindrical member has an open top end and an open bottom end, the inner circular ring extends radially outward from the top end of the vertical cylindrical member, and the vertical cylindrical member of the middle tray has a height less than a height of the annular side of the middle tray.
